(19) United States
(12) Patent Application Publication
(10) Pub. No.: US 2012/0123877 A1
(43) Pub. Date: May 17, 2012

(54) POINT OF INTEREST TRACKING WITH SPECIFIC RETAILER ACCREDITATION

(75) Inventors: Jeff BUICK, Calgary (CA); Celia RUSHFORD, Calgary (CA); Kevin FRANCO, Calgary (CA); Wayne LOGAN, Calgary (CA); Geoff PICKERING, Calgary (CA); Cameron CHELL, Calgary (CA)

(73) Assignee: Enthrill Distribution Inc., Calgary (CA)

(21) Appl. No.: 13/297,546

(22) Filed: Nov. 16, 2011

Related U.S. Application Data
(60) Provisional application No. 61/414,078, filed on Nov. 16, 2010.

(51) Int. Cl. G06Q 30/02

(52) U.S. Cl. 705/14.73

(57) ABSTRACT

A method and system is provided for crediting presenters of product advertisements for purchases related to a consumer's initial point of interest. A presenter provides a previously generated, point of interest tracking (POIT) code on advertising media, the POIT code having an internet address for fulfillment website site, and the indentify of the presenter embedded therein. A consumer scans the POIT Code on an e-device and establishes communication with the fulfillment website, the presenter identity being extracted and tracked, any purchases thereafter being credited to the presenter. Vendors can now identify and remunerate an initial retailer or presenter for their role in closing the cycle from a consumer's point-of-interest through purchase.

### CROSS-REFERENCE TO RELATED APPLICATION

This application claims the benefit of U.S. provisional application 61/414,078, filed Nov. 16, 2010, the entirety of which is incorporated herein by reference.

### FIELD OF THE INVENTION

This invention is related to tracking an initial presentation of a vendor's product to a consumer and once acted upon, accreditation of the presenter for purchases resulting therefrom. More particularly a consumer indicates interest in a supplier's product by scanning a target code, unique to a retailer or presenter of the product, and tracks the consumer's relationship through to an online purchase, regardless of passage of time or the consumer's location, for crediting the purchase to the presenter.

### BACKGROUND OF THE INVENTION

It is known to scan a two-dimensional (2-D) code, such as a QR CODE™ (trademark of Denso Wave Incorporated, Japan and subject of U.S. Pat. No. 5,726,435), using a user's mobile device or Smartphone. An application on the device directs the user to a website encoded in the QR Code. Codes can direct users to an intermediate online service, which links the user with the target website, and also identifies when and which marketing campaign resulted in the user's inquiry. Each campaign can be associated with a different target website, ultimately resulting in the same end information presented for the user, but being unique for tracking purposes.

A user may or may not become ever become a consumer, and an online store, and activity conducted thereat is independent of the user's initial interest. There is still a demonstrated need for a process by which the initial presenter can reap the benefit of their success in capturing the interest of the consumer on behalf of a vendor.

### SUMMARY OF THE INVENTION

While prior art tracking of scanned, two-dimensional (2-D) codes has assisted vendors in analyzing the effectiveness of certain forms of marketing campaigns, what has not been available to date is the ability to identify and remunerate an initial retailer or presenter for their role in closing the cycle from point-of-interest through purchase.

Herein, methods and systems are provided for creating and retaining a relationship between a presenter and a consumer from the initial point of interest through to the sale, regardless of passage of time or the consumer's location. Commercially, both presenters and vendors are motivated to foster this relationship for mutual benefit.

In general, a point of interest tracking (POIT) process occurs when a potential purchaser or consumer scans or inputs a code into a mobile electronic device, or e-device, and ensures the presenter will receive credit for any purchase that is made as a result of this process. The consumer can share the result of the scan with other consumers, such as friends, family or other designate, increasing the scope of accreditation to a presenter.

A retailer or presenter is provided with a unique tracking uniform resource locator (URL) associated with or embedded in a point of interest tracking code (POIT code), generated to be unique for that presenter, and displayed by the presenter in their advertising media, that POIT code being scannable by an e-device. Some examples where a POIT code would be presented could include geographical location including a brick and mortar place of business or in a variety of print media or digital display media distributed or displayed anywhere. The POIT code can be scanned or input and interpreted by the e-device. The consumer scans or otherwise inputs or receives the POIT code. In an embodiment, a POIT code may be an encoded image, such as a 2-D code or an coded image, linked to an online website for purchasing the vendor's targeted products. Decoded, the POIT code provides a destination network address or a destination URL and whatever other additional information is required to identify the presenter that displayed the POIT code.

Through the link, typically accessed through the e-device used to scan the code, the consumer browses the destination URL and views product targeted by the POIT code. An e-store is associated with the destination URL. The browsing session is monitored for any purchases made through the e-store, by a consumer who arrived via the presenter's POIT code. Depending on agreement between vendor and the presenter, this accreditation can be extended to subsequent arrivals at the e-store via the POIT code, and to any related purchases at the e-store associated with the POIT code. Accordingly, in a full implementation of system, the presenter will receive credit for any such purchases, and any other purchase promoted by the presenter and introduced to the consumer through the POIT code. Scanning the POIT code creates a relationship between the consumer and the presenter that exists at that moment and persists through the tracking URL beyond the point of initial interest.

The process allows a presenter to retain a relationship with a consumer from the initial point of interest through to a purchase for purposes of accreditation, regardless of passage of time or the consumer's location, for purposes of crediting the sale to the presenter.

In one broad aspect, a method for crediting presenters of product advertisements for purchases made by a consumer is provided comprising first receiving from the consumer, at a fulfillment server, a tracking uniform resource locator (URL) including at least a destination URL and a presenter identity of a specific presenter of a plurality of presenters. Further, one extracts at least the destination URL and the presenter identity of the specific presenter and establishes a browsing session at the destination URL between the consumer and the fulfillment server. The browsing session is established for browsing an electronic catalogue of products, associating the presenter identity with activity occurring during the browsing session, and facilitating purchase of one or more products from the electronic catalogue. Where purchase are made, the method further credits the specific presenter at least for purchases made during the browsing session.

In another aspect, the method further comprises generating a point of interest tracking code (POIT code), at a code generation server, for embedding the tracking URL and presenter identity of the specific presenter therein. The step of receiving of the tracking URL from the consumer further comprises decoding the POIT code for extracting at least the tracking URL therefrom; and establishing a connection with the internet between the consumer and the tracking URL for initiating the browsing session. The tracking URL may be stored for later retrieval and establishing the browsing session as described above for accreditation of purchaser to the specific presenter.

In broad system aspect, the method cam be implemented in a system for crediting presenters of product advertisements for purchases made by a consumer comprising: a fulfillment server implementing at least a fulfillment module for receiving a tracking URL from a consumer, the tracking URL including at least a destination URL, for initiating a browsing session by a consumer at the destination URL, and a presenter identity of the specific presenter of a plurality of presenters. The server further comprises a shopping cart model for presenting an electronic catalogue and facilitating purchase of one or more products by the consumer; and a tracking module for tracking activity of the consumer at the fulfillment module including at least purchases made by the consumer, and crediting the specific presenter for any such purchases. In another aspect, the system further includes a code generation server implementing at least a code generation module for generating a point of interest tracking code (POIT code) associated with and for display by the specific presenter, the code embedding at least the tracking URL therein, the code being capable of being scanned by a mobile electronic device. The code generation code and the fulfillment module may be implemented on different servers or on the same server.

The above system and methodology can be implemented as part of a computer system comprising one or more computers, said computer system programmed, via executable code stored on at least one computer readable storage medium, to perform the method for crediting presenters of product advertisements for purchases made by a consumer. The computer system can execute computer-executable instructions, provided on non-transitory computer-readable medium storing said computer-executable instructions so that, when executed on one or more processors, cause the one or more processors to perform the method for crediting presenters of product advertisements for purchases made by a consumer.

### BRIEF DESCRIPTION OF THE DRAWINGS

FIG. 1 is a logic flow diagram illustrating the interactions between the various blocks of FIG. 1.

FIG. 2 is a block diagram illustrating one embodiment of a point of interest accreditation system;

FIG. 3 is a flow chart illustrating an example scenario where a consumer makes a purchase through a fulfillment module of a first presenter; and

FIG. 4 is a flow chart illustrating an example scenario where a consumer makes a purchase through a fulfillment module for the same product of a second presenter.

### DESCRIPTION OF THE PREFERRED EMBODIMENTS

It is acknowledged that the increasing utilization of e-commerce models for the online presentation of products, online purchase and direct-to-consumer shipping have not completely integrated or recognized the large consumer base which experiences their first point of interest for a product at a conventional brick and mortar site or though other conventional physical advertising media. Herein, retailers or presenters of products are provided with an incentive, accreditation and remuneration process and system for consumer purchases made at an e-commerce website, the consumer's arrival at which being first initiated by the consumer's interest in a presenter's physical-advertising media. In other words, presenters of product advertisements are credited for purchases made by a viewing consumer.

An embodiment of a point of interest tracking (POIT) accreditation system is provided for crediting a presenter for an ultimate purchase made by a consumer. A POIT code is displayed by a presenter for the advertisement of a vendor's goods or services, herein termed collectively as the “product”. The consumer sees the presenters display and the POIT code thereon. The consumer scans the POIT code with their mobile electronic device which commences a tracking process of an interaction of consumer and presenter. The tracking process directs the consumer to a destination e-commerce site having with product information and an e-commerce opportunity for obtaining the product. Ultimately the presenter is credited in the case of the consumer's purchase of said product.

In the typical scenario, the consumer scans the POIT code, is directed to the destination e-commerce site embedded in the POIT code, makes an online purchase of the vendor's product related to the presenter's advertising media for the vendor's product. The presenter receives remuneration for having initially stimulated the purchase. The e-commerce site completes the transaction and ships, uploads or otherwise delivers the product for receipt by the consumer.

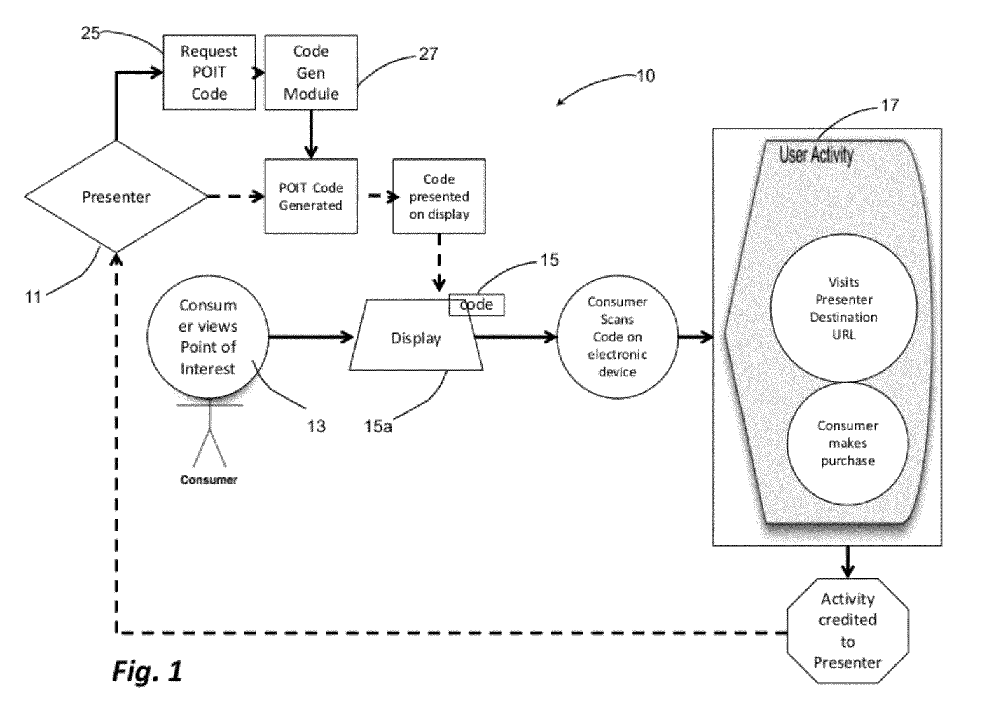

Accordingly in one embodiment, and having reference to FIG. 1, a POIT accreditation system 10 is provided for crediting a presenter 11 for an ultimate purchase made by a consumer 13 introduced to the product by the presenter 11. The consumer 13 views a display 14 at a point of interest bearing a presenter's POIT code 15. The consumer 13 scans the POIT code 15 with an e-device 19 which is then hardlinked to destination URL hosting an online fulfillment service or module 17. The consumer 13 reviews products offered thereon and, based upon the consumer's activity, such as making a purchase, the presenter 11 is credited for that activity with some form of consideration including a commission or other agreed form of remuneration. The presenter typically requests a POIT code and attends a code generation module 27 for generation one or more unique POIT codes for one or more products, all of which are to be advertised through presenter's advertising media or display. The code generation module 27 can be associated with the fulfillment module 17 or be a separate service.

### Presenters and POIT Code

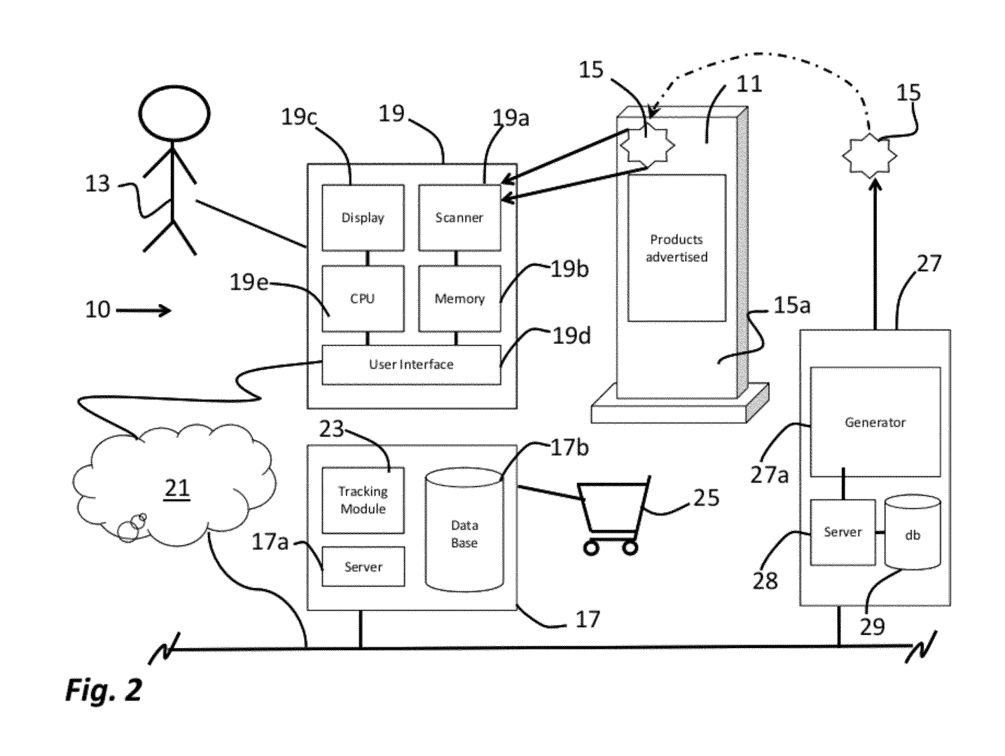

In greater detail, and with reference to FIG. 2, a consumer has a mobile electronic device or e-device 19 capable of scanning POIT code 15. The e-device 19 can access the internet 21. Similarly the fulfillment module 17 includes a communication interface for communication with the internet 21. The fulfillment module further includes, or is in communication, with a shopping cart model 25. As described generally in U.S. Pat. No. 5,960,411 to Amazon.com, Inc, when the purchaser selects an item from the electronic catalogue, a server computer system, of the shopping cart model 25, metaphorically adds that item to a shopping cart. When the purchaser is done selecting items, then all the items in the shopping cart are “checked out” (i.e., ordered) when the purchaser provides billing and shipment information. In some models, when a purchaser selects any one item, then that item is “checked out” by automatically prompting the user for the billing and shipment information.

The POIT code 15 is displayed by the presenter 11, the presenter 11 being graphically illustrated or symbolized herein by the advertising media through which the product is presented to the consumer 13. The presenter 11 applies or otherwise displays the POIT code 15 on advertising media 15a, fancifully illustrated in this embodiment as a display stand which presents product to the consumer 13. The POIT code 15 is related to that product being advertised. The POIT code 15 is merely intended to be scannable and thus may be embedded or displayed on physical media. For example, one form of media 15a accessed and viewable by consumers is that displayed at conventional brick and mortar sites of the presenter 11 or through other of the presenter physical advertising media display through the usual advertising channels. Examples of advertising media scannable by an e-device 19 and presenting merchandise for a vendor include posters, display stands, newspapers, retail location merchandisers, ad display, pages in magazines, car and transit ads, displays, clothing, calendars, concert tickets, conference passes, in store display, articles of clothing, coffee cups, advertisements displayed on buildings, and various digital advertising media including in-store TV screen, touch screen, television, location-based app results. The code 15 is a scannable object which includes a link or otherwise unambiguously establishes a relationship between the consumer 13 and a fulfillment module 17 from which the consumer may make a purchase. In one embodiment the POIT code 15 comprises a tracking URL containing a destination URL (network or web address) which hardlinks the consumer 13 to the fulfillment module 17. The tracking URL also contains information identifying the presenter 11, from a plurality of presenters.

Typically there are a multiplicity of presenters, consumers, and vendors. The vendors have an online presence represented by the fulfillment module, either host by the vendor or another service on behalf of the vendor.

More than one presenter can advertise the product of a vendor. Some presenters may have a main corporate entity with a plurality of unique presenters, such as franchisees or distinct physical outlets or kiosks. Each outlet can be a unique presenter. The presenters may merely act as an advertising medium for a vendor, or the presenter could be the vendor. The vendor is the service which sells the product. A vendor can implement the system in its entirety, having one or more vendor-sponsored presenters and offer a shopping cart model for purchase and delivery functions. Alternatively, a vendor could utilize an intermediary service for one or more of the functions of account management, POIT code generation, e-device application programs, shopping cart models and accreditation management. However implemented, a fulfillment service connects consumers to the vendor's products. The consumers access a shopping cart model through which appropriate accreditation is tracked back for credit to a specific presenter.

### Code Generation

The POIT code 15 is generated by a code generation module 27 having a code server 28 for managing a code generator 27a and an account database 29. Code server 28 includes a processor, memory and application software for implementing various functions including the code generator 27a and internet connectivity. The software and operating system can be executable code that is stored in a computer readable storage medium. The processor and application software receive inputs and concatenate strings including the destination URL and values representing presenter identity. Typically, the presenter makes a request for a POIT code which is related to a product or products available from a particular fulfillment module which can be represented by a destination URL. An account service, such as that implemented in either the code generation module 27 or fulfillment module 17, provides a client account for presenters, assigning or receiving values for presenter identities, and for the generation of the POIT code which includes data for connecting the consumer with the fulfillment module for browsing and potentially purchasing the advertised product, and which identifies the presenter 11. A presenter representing multiple products or multiple vendors could have multiple POIT codes for display in their advertising media.

The code generation module 27 is implemented on code server 28 which can be part of the fulfillment module 17 or a separate code generation module 27. The code generator 27a is linked to the fulfillment to associate the POIT code 15 with the appropriate fulfillment module 17 for the vendor's product.

The POIT code 15 is a scannable object which includes a link or otherwise unambiguously establishes a relationship with the fulfillment module 17. Such scannable objects can include graphical tags, short message service (SMS) tags, radio frequency identification tag (RFID) and virtual tags such as those identified by geographical coordinates defined by GPS. A suitable POIT code 15 typically comprises a two-dimensional (2-D) graphical code such as a QR Code. QR Code is registered trademark of Denso Wave Incorporated, Japan and is described in U.S. Pat. No. 5,726,435 to Hara et al., the entirety of which is incorporated by reference. Other popular 2-D codes include those by EZCode, a trademark of Scanbuy, Inc, New York. Other graphical tabs for POIT Codes can include images registered with a database of images, the registered image being linked to a fulfillment service associated with a presenter. Such a scenario was introduced by Microsoft Corporation, Seattle Wash., in about 2007 in their software prototype “Lincoln” which matches pictures taken on cell phones with pre-tagged pictures in a database. Example images include 2-D objects such as those on movie posters and DVD covers. The concept was extended to connecting the internet with real-world advertisements and company logos.

Herein, in an embodiment, the POIT code is a 2-D code, within which is embedded a hardlink, being a form of object hyperlinking to the fulfillment module. The POIT code includes or enables association with an online, internet presence of the fulfillment module, typically an e-commerce website. The hardlink establishes a reference link between the physical world object, the 2-D code on the presenter's advertising media, and a destination uniform resource locator (URL) or destination URL representing the fulfillment service. The destination URL is embedded in a tracking URL including text appended to the end of the destination URL for including data such as a unique presenter identity (PID), and potentially additional data.

An example tracking URL might be “http://www.destination_url_fulfillment.com?PID=1234 where the PID=1234 is the presenter's unique identity. Another POIT Code, for another presenter, for the same fulfillment module would embed a similar but unique code such as “http://www.destination_url_fulfillment.com?PID=9876 where the PID=9876 is the second presenter's unique identity. In another case, the first presenter PID=1234 might have a second POIT code for a different targeted set of products and another POIT code could be generated such as “http://www.vendors_own_url_fulfillment.com?PID=1234 again having the first presenter's PID=1234 as their unique identity.

In some cases one might append other data, for example “MEDIA” which may advise if the POIT code was scanned from their in-store display, printed advertising flyer, transit advertising or other media for that particular presenter 11. Another example of appended text for a tracking URL could be “PRODUCT” which may be a specific product or type of product associated with a POIT code. Of course the syntax of the tracking URL can be set forth in various forms including other alphanumeric coding which is not necessarily reader-friendly. In alternate embodiments, the tracking URL can further include data identifying the customer's e-device or customer's identity.

### Scanning and Extraction

The POIT code 15 is scanned by the consumer 13 using a mobile electronic device or e-device 19. The e-device 19 comprises a scanner or camera 19a, a memory 19b, a processor or CPU 19e, a display 19c, and a wireless interface 19d for cellular or wireless connectivity to the internet or World Wide Web 21. The e-device 19 further includes an operating system and application software or programs operable thereon including for reading the POIT code 15 and decoding data encoded therein into the memory 19b of the e-device 19. The application software and operating system can be executable code that is stored in a computer readable storage medium, typically solid-state derives or flash memory. The application program provides a consumer interface for initiating and handling the particulars necessary to ensure error-free scanning of the POIT code 15, parsing and decoding of the code, and managing the data contained therein. One can refer to discussions of mobile electronic devices having scanning capabilities and internet connectivity such as that described in U.S. Pat. No. 6,448,979 to Schena et al. the entirety of which is incorporated by reference. Examples of e-devices 19 include those having browser or sharing capability such as a laptop, smartphone, tablet, e-reader, and netbooks. Examples of smartphone's included iPhones (trademark of Apple Inc.) and other phones such as those having Android (trademark of Google Inc.) operating systems.

The application program extracts the tracking URL from the code 15. The consumer's e-device 19 establishes a link with the fulfillment module 17 at the tracking URL. The link is made with the e-device's communications port or interface 19d for establishing communications with the network, typically via cellular or wireless network to the internet. Communications are established between the mobile electronic device and the destination URL. The communication is bi-directional for uploading and downloading data including presenter accreditation data and browsing data shown in the display 19c. The consumer 13 is directed to the destination URL for the fulfillment module 17. At the fulfillment module 17, the tracking information, such as the presenter identity PID, is stripped for tracking purposes and the consumer 13 is directed to the embedded destination URL of the fulfillment module 17.

The application program can be configured to store the extracted data for each scanned POIT code for later or repeated retrieval. The data associated with the POIT code 15 can persist in the memory 19b (such as flash or static memory) for an extended period of time and can be retrieved for establishing or re-establishing connection between the e-device 19 and the fulfillment module 17 at any given point of time. The stored data, such as the tracking URL, maintains the association of the consumer's point of interest at a specific presenter and that product available from the particular destination URL or fulfillment module. A consumer retrieve a previously stored tracking URL and establish a connection with the internet between the consumer and the tracking URL. If the tracking URL extracted from a POIT code is lost, then the presenter association and future accreditation is also lost.

### Fulfillment Module

The tracking URL is received from the consumer at the fulfillment module 17. As stated, tracking information, such as the presenter identity PID and the destination URL, is stripped from the tracking URL and the consumer 13 is directed to the embedded destination URL of the fulfillment module 17. A parsing module, of the fulfillment module, strips the various data from the tracking module. Hence, multiple consumers, having scanned different POIT codes, can end up at the same destination URL and have provide unique presenter identities.

A consumer's browsing session is initiated wherein the consumer 13 can browse vendor's product, product information, and the consumer 13 has an opportunity to purchase the product. In one embodiment, the fulfillment module 17 is typically a vendor website which implements a shopping cart module for enabling the consumer to make a purchase. The website can be implemented at a fulfillment server 17a such as that hosted by the vendor. Fulfillment server 17a includes a processor, memory and application software for implementing various functions including internet connectivity, and a product database or electronic catalogue 17b of products. The software and operating system can be executable code that is stored in a computer readable storage medium. The parsing module, or account service and browsing interfaces for interconnection with a presenter or with a consumer's e-device, are all examples of implementations of the executable code and application programs which can function at the fulfillment module 17. In another embodiment, the fulfillment module 17 is hosted by a third party fulfillment server 17a and is different from the vendor website. In an embodiment receiving of the tracking URL at the fulfillment server 17a and the generating of the POIT code at a code generation server 28 occur at a common server.

The fulfillment module 17 includes a tracking module 23 for tracking activity of the consumer at the fulfillment module including at least purchases made by the consumer, as associated by the extracted presenter identity PID. The consumer 13 can browse an electronic catalogue of the vendor's products at the fulfillment module 17 and can make a purchase using a shopping cart model 25. The shopping cart model 25 may be integrated with the fulfillment module 17 or provided by others for facilitating purchase of one or more products from the electronic catalogue. The fulfillment module 17, such as through the tracking module 23, determines association between the POIT code and the product for identification of the specific presenter who displayed the POIT code, simply for determining association between the specific presenter and the product purchased.

The tracking module 23 manages accreditation to the presenter 11 including establishing an appropriate remuneration to credit to the presenter 11, including monitoring the purchase value or quantity or other classification of product. Various methods of establishing accreditation value can be applied as agreed between presenter and vendor. Accreditation may include tracking purchases which were not the subject of the initial subject of the initial POIT code and connection to the fulfillment module 17. For example, a consumer may perform additional browsing at the fulfillment module 17 or hyperlink to other related shopping cart models 25 or related fulfillment modules 17 and purchase additional product or products, those not necessarily being the products initially associated with the POIT code. The vendor/presenter agreement may acknowledge that, but for the initial POIT code direction to the fulfillment module 17, the vendor would not have sold those products.

The tracking module 23 is also capable of managing the parameters particular to the mode of accreditation pursuant to the vendor/presenters agreement including value, quantity or classification of products. The product purchased by the consumer 13 through the fulfillment module 17 is provided to the consumer 13 through one or many conventional means including physical shipping, e-content download, controlled online access or e-content activation codes.

### Purchase

When a consumer 13 makes a purchase, either at that session or some later session associated or fulfilled by the tracking URL, the presenter 11 who displayed the POIT code 15, is credited with the purchase and remuneration is made according to the business relationship or agreement formed between the vendor and the presenter 11. The fulfillment module 17 may also be accessible directly by other, direct-access consumers, such as those not having scanned a POIT code 15 and not having been associated with a presenter 11. Purchases made by direct-access consumers, absent the tracking URL entry to the fulfillment module 17, would not result in accreditation to any particular presenter. The tracking module 23 distinguishes this direct consumer from a consumer who accessed the fulfillment module 17 through a scanned POIT code 15. The distinguishing factor is the tracking URL embedded in the POIT code 15. A consumer may successfully refer or share their tracking URL however with others, the tracking URL identifying the presenter 11. Others subsequently can access the fulfillment module 17 using the tracking URL and purchases made therein are accredited to the presenter 11. The consumer may share the tracking URL with friends, family or other designate.

### EXAMPLES

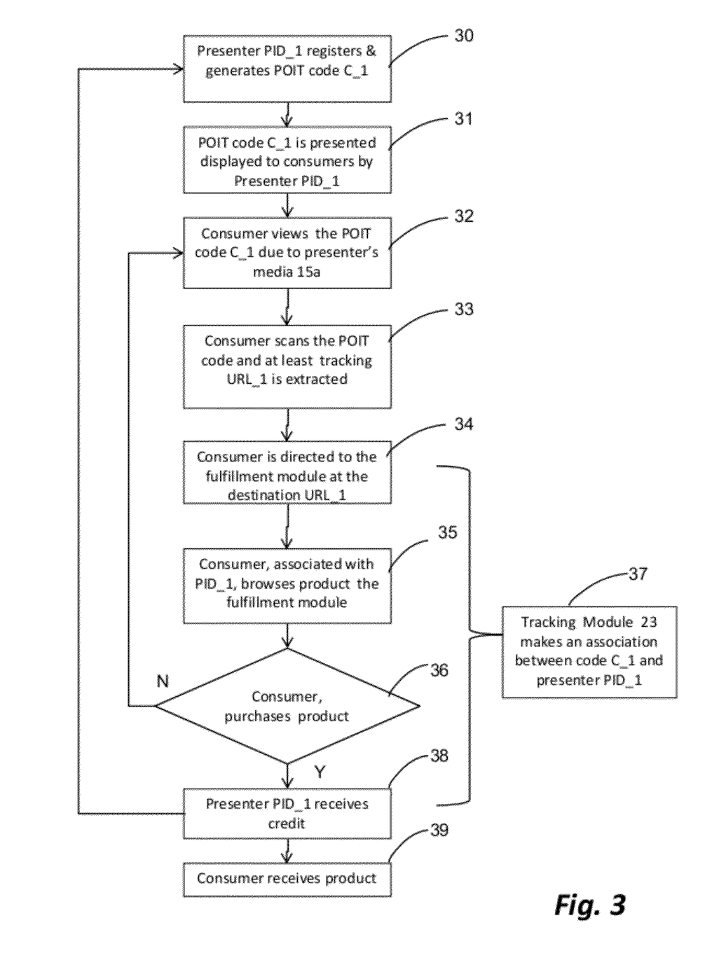

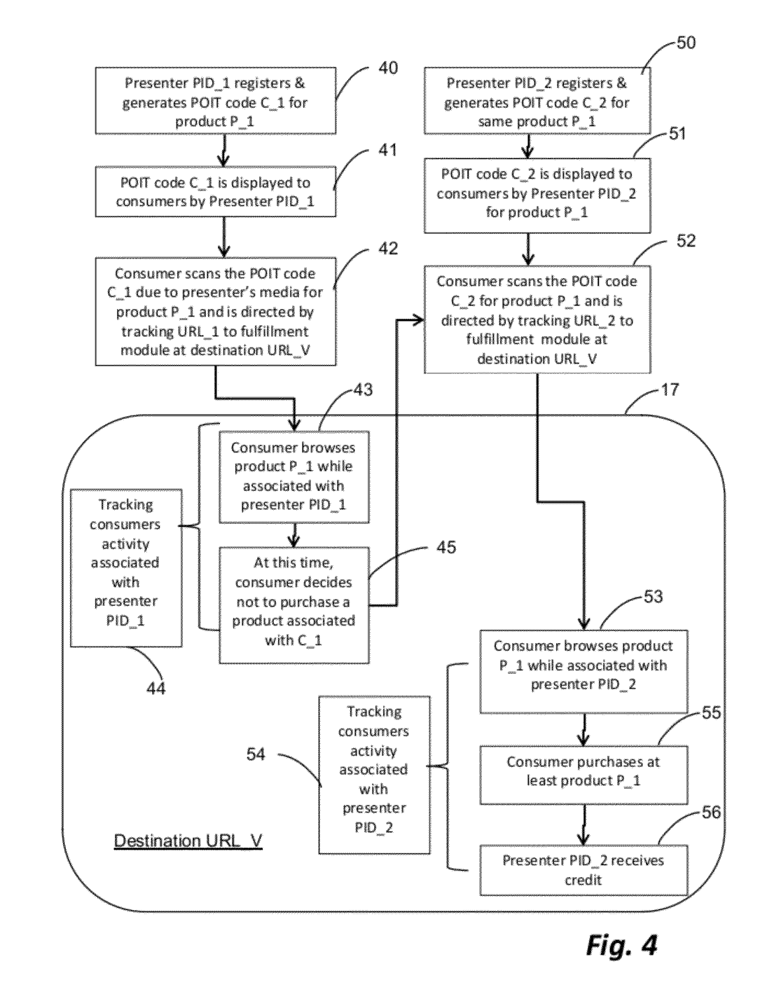

Turning to FIGS. 3 and 4, a method is provided for accrediting the presenter 11 for a purchase initiated by a consumer's interest in a presenter's advertising media 15a. One presenter 11, having a unique identity PIDx of a plurality of presenters 11,11 . . . , having a plurality of unique identities PID1 to PIDn, registers with the code generation module 27 for generating a POIT Code 15, referenced in these examples a Cx of a plurality of presenter POIT Codes (C1 to Cn). The presenter PIDx has a relationship with the vendor or vendor's associated with fulfillment module 17 for accreditation or remuneration based upon consumer's interest and purchase of products presented by that presenter PIDx. Herein, presenters 11 and presenter's identities PID1 to PIDn are used interchangeably. The POIT Code Cx is linked to a tracking URLx within which is concatenated with tracking information including the destination URLx and presenter's identity PIDx. The destination URLx can be a network address of a vendor's e-store or intermediary fulfillment module having an e-store, typically represented by a shopping cart module 25 described above. A single fulfillment module at destination URLx can be accessed by a plurality of different tracking URL's, each tracking URL having the same destination URL with different presenter PIDx embedded therein. In other words, one fulfillment module, at one destination URL would be accessed by different presenters PID_1, PID_2 . . . advertising the same products. A plurality of destination URLs, URL1 to URLn are available for a plurality of vendors. As stated earlier, some destination URLs handle products for a plurality of vendors, and others are limited to a single vendor.

In greater detail, and having reference FIG. 3, and with reference also to FIG. 2 for system references, at block 30, one presenter 11, having a unique identity PID_1 registers with the code generation module 27 for generating at least one POIT Code C_1. At block 31, presenter PID_1 places their POIT code C_1 on advertising media 15a for presentation and exposure to consumers 13 having mobile electronic devices or e-devices 19. At block 32, the consumer 13 views the code 15 upon the presenter's media 15a.

At block 33, the consumer, having been introduced and interested in the products represented by the presenter's media, scans the code C_1 using their e-device 19. The e-device 19 includes an application program PRG for decoding the POIT code 15 and extracting embedded tracking data including the tracking URL_1 which includes the destination URL_1 and PID_1. At block 34 the consumer's e-device directs the consumer to the tracking URL_1 for the destination URL_1 of the fulfillment module 17. Herein, each e-device is assumed to be associated with one consumer although it is possible that multiple individuals share an e-device. Further, the tracking URL_1 may be shared with others, the presenter potentially being credited for multiple purchases by multiple consumers from a single scan. The tracking URL_1 and destination URL_1 can be a mobile mTLD (mobile top level domain) website or one is directed to a full TLD website, either of which is displayed at the e-device such through a Safari browser interface (Apple Inc.), Firefox (Mozilla Foundation), or Chrome (Google Inc.).

At block 35, the consumer 13 browses the vendor's products and any information related thereto at the fulfillment module 17. At block 36, the consumer may or may not make a purchase. At block 37. the tracking module 23 monitors the consumers activity which is associated with the initial introduction by presenter PID_1. If not, the session and tracking related to that POIT code scan is complete and a consumer is released, perhaps to visit this presenter PID_1 again or some other presenter PID_x at some later date. If the consumer does make a purchase, e-store e-commerce or shopping cart model 25 then, at block 37, the tracking module 23 makes the association between the tracking URL_1, specific to that scanned code C_1, and the presenter PID_1. At block 38, the tracking module 23 credits the presenter 11 according to the remuneration relationship. At block 39, product, purchased by the consumer 13 through the fulfillment module 17, is provided to the consumer 13.

FIG. 4 is a flow chart illustrating a scenario where a consumer 13 does not make a purchase of a specific product P_1 associated with a first code C_1 scanned by them but returns to the fulfillment module 17 via scan of second code C_2, for the same product P_1. Both presenters are representing a vendor for product P_1 available for purchase at a fulfillment module 17 at destination URL_V.

In this scenario, the consumer 13 visits a first presenter PID_1 and later visits a second presenter PID_2 carrying the same product P_1. Only presenter PID_2 receives credit for a consumer's purchase of product P_1, despite having first viewed the product in advertising media of presenter PID_1.

At block 40, a first presenter 11, having a unique identity PID_1, registers with the code generation module 27 for generating at least one POIT Code C_1. Code C_1 includes tracking data including tracking URL_1 which includes at least the destination URL_V and first presenter identify PID_1.

At block 50. a second of the plurality of presenters 11, having a unique identity PID_2, registers with the code generation module 27 for generating at least one POIT Code C_2. Code C_2 includes tracking data including tracking URL_2 which includes at least the destination URL_V and second presenter identify PID_2.

At block 41, presenter PID_1 places their POIT code C_1 on their advertising media for presentation and exposure to consumers 13 having mobile electronic devices or e-devices 19. Similarly at block 51, presenter PID_2 places their POIT code C_2 on their advertising media for presentation and exposure to consumers 13.

At block 42, the consumer, having been introduced and interested in the products represented by the media of first presenter PID_1, scans the code C_1. The consumer's e-device extracts embedded tracking data including the tracking URL_1 which includes the destination URL_V and first presenter identify PID_1. The consumer's e-device directs the consumer to the fulfillment module 17.

At block 43 the consumer 13 browses the vendor's products, including product P_1. At block 44, the tracking module monitors the consumer's activity to see whether a purchase is made by the consumer 13 which can be accredited to presenter PID_1. As shown at block 45, for the purposes of this example, this consumer decides not to purchase the product at this time. If the consumer loses the tracking URL_1, or otherwise does not retain the tracking URL_!, the consumer may decide to rescan a POIT Code for the product P_1, but not necessarily from the media of the first presenter PID_1.

Thereafter at block 52. the consumer scans another code C_2 presented by second presenter PID_2, interested again in the same product P_1. The consumer's e-device again extracts embedded tracking data including this time tracking URL_2 which includes the same destination URL_V and second presenter identify PID_2. Again, the consumer's e-device directs the consumer to the same fulfillment module 17.

At block 53 the consumer 13 browses the vendor's products, including the same product P_1. At block 54, the tracking module monitors the consumer's activity to see whether a purchase is made by the consumer 13 which can be accredited to presenter PID_2. Note any tracking of first presenter's contribution, regardless of being first in time, is now irrelevant. At block 55, when the consumer makes a purchase of subject product P_1, tracking module accredits second presenter PID_2.

Generally, to ensure accreditation to an initiating presenter 11, there must be a persistent link to the PIDx, such as through the tracking URLx. In other embodiments, the consumer 13 may return to the destination URL (or fulfillment module 17) and seek to purchase product seen earlier by retrieving the tracking URLx stored on his e-device 19. If the customer 13 returns using the tracking URLx, saved from a previous session, then the process is simply as described earlier. This may be the case whether or not a purchase is ultimately made from the same e-device.

As shown in FIG. 4, tracking URLs of multiple presenters 11 can be directed to the same fulfillment module 17 or in other embodiments, to different fulfillment modules 17. Tracking URLs can also be specific to the nature of a product. For example, presenter PID_1 sells books and coffee. Code C_1 is generated for coffee and code C_2 is generated for books. Tracking URL_1 embedded in code C_1 takes a consumer to first fulfillment module FM_1 and tracking URL_2 embedded in code C2 takes a consumer to second fulfillment module FM_2. First fulfillment module FM_1 has an electronic catalogue relating to only coffee and second fulfillment module FM_2 has an electronic catalogue relating to only books. In another instance, URL_1 and URL_2 can also be configured to establish connection between the consumer 13 and one common fulfillment module FM_V. Fulfillment module FM_V has electronic catalogues relating to both coffee and books and the consumer 13 can navigate both these catalogues to make a purchase.

Remuneration to a presenter 11 for a purchase depends on an agreement established between the presenter 11 and the vendor. One form of accreditation could be based on remuneration for every purchase made by the consumer 13 through the fulfillment module 17. In another model, the presenter 11 may only be credited for the first purchase made by the consumer 13. The accreditation process and system does not dictate any specific methodology for calculation of remuneration.

Various embodiments discussed herein may be combined with each other in appropriate combinations in connection with the system described herein. Additionally, in some instances, the order of steps in the flow charts or flow diagrams may be modified, where appropriate. Further, various aspects of the system described herein may be implemented using software, hardware, and/or a combination of software and hardware. Software implementations of the system described herein may include computer-executable instructions or executable code that is stored in at least one non-transitory computer readable storage medium and be executed on one or more computers having one or more processors. The computer-executable instructions can cause the one or more processors to perform acts including steps of various of the method embodiments described herein.

The computer readable storage medium may include a computer hard drive, ROM, RAM, flash memory, portable computer storage media such as a CD-ROM, a DVD-ROM, a flash drive and/or other drive with, for example, a universal serial bus (USB) interface, and/or any other appropriate tangible storage medium or computer memory on which executable code may be stored and executed by a processor.

The embodiments of the invention for which an exclusive property or privilege is claimed are defined as follows:

1. A method for crediting presenters of product advertisements for purchases made by a consumer comprising:
receiving from the consumer, at a fulfillment server, a tracking uniform resource locator (URL) including at least a destination URL and a presenter identity of a specific presenter of a plurality of presenters;
extracting at least the destination URL and the presenter identity of the specific presenter;
establishing a browsing session at the destination URL between the consumer and the fulfillment server for:
browsing an electronic catalogue of products,
associating the presenter identity with activity occurring during the browsing session,
facilitating purchase of one or more products from the electronic catalogue; and
accrediting the specific presenter at least for purchases made during the browsing session.

2. The presenter accreditation method of claim 1 further comprising:
generating a point of interest tracking code (POIT code), at a code generation server, for embedding the tracking URL and presenter identity of the specific presenter therein; and
wherein the receiving of the tracking URL from the consumer further comprises
decoding the POIT code for extracting at least the tracking URL therefrom; and
establishing a connection with the internet between the consumer and the tracking URL for initiating the browsing session.

3. The presenter accreditation method of claim 2 wherein the receiving of the tracking URL at the fulfillment server and the generating of the POIT code at a code generation server occur at a common server.

4. The presenter accreditation method of claim 1 further comprising storing the tracking URL for subsequent retrieval and use by the consumer or designate.

5. The presenter accreditation method of claim 1 wherein the receiving of the tracking URL from the consumer further comprises retrieving a previously stored tracking URL and presenter identity therein.

6. The presenter accreditation method of claim 1 further comprising:
generating a point of interest tracking (POIT) code, at a code generation server, for embedding the tracking URL and presenter identity therein;
displaying the POIT code by the specific presenter for viewing by the consumer; and
wherein the receiving of the tracking URL from the consumer further comprises scanning the POIT code for decoding of the POIT code for extracting at least the tracking URL therefrom and establishing a connection with the internet between the consumer and the tracking URL for initiating the browsing session.

7. A method for crediting presenters of product advertisements comprising:
scanning a point of interest tracking code (POIT code) by a mobile electronic device, the POIT code being associated with and for display by a specific presenter of a plurality of presenters, the POIT code embedding at least a tracking URL including at least a destination URL and a presenter identity for the specific presenter of the plurality of presenters;
extracting at least the destination URL and the presenter identity;
establishing communication between the mobile electronic device and the destination URL;
enabling a browsing session of an electronic catalogue at the destination URL;
associating the specific presenter with the browsing session;
facilitating purchase of one or more products from the electronic catalogue;
determining association between the specific presenter and the product purchased; and
crediting the specific presenter for the purchased product.

8. A system for crediting presenters of product advertisements for purchases made by a consumer comprising:
a fulfillment server implementing at least a fulfillment module for receiving a tracking URL from a consumer, the tracking URL including at least a destination URL, for initiating a browsing session by a consumer at the destination URL, and a presenter identity of the specific presenter of a plurality of presenters, the server further comprising:
a shopping cart model for presenting an electronic catalogue and facilitating purchase of one or more products by the consumer; and
a tracking module for tracking activity of the consumer at the fulfillment module including at least purchases made by the consumer, and crediting the specific presenter for any such purchases.

9. The presenter accreditation system of claim 8 further comprising:
a code generation server implementing at least a code generation module for generating a point of interest tracking code (POIT code) associated with and for display by the specific presenter, the code embedding at least the tracking URL therein, the code being capable of being scanned by a mobile electronic device.

10. The presenter accreditation system of claim 9 further comprising a communication interface for establishing communication between the mobile electronic device and the destination URL.

11. The presenter accreditation system of claim 9 wherein the mobile electronic device further comprises:
a scanner for scanning the POIT code from advertising media;
a processor and application program operable therein for decoding the POIT code for extracting at least the tracking URL therefrom; and
a communication interface for establishing communication between the mobile electronic device and the destination URL.

12. The presenter accreditation system of claim 9 wherein the code generation module and the fulfillment module are implemented on the same server.

13. The presenter accreditation system of claim 9 wherein the code generation module and the fulfillment module are implemented on different servers.

14. A computer system comprising one or more computers, said computer system programmed, via executable code stored on at least one computer readable storage medium, to perform a method for crediting presenters of product advertisements for purchases made by a consumer that comprises:
receiving from the consumer, at a fulfillment server, a tracking uniform resource locator (URL) including at least a destination URL and a presenter identity of a specific presenter of a plurality of presenters;
extracting at least the destination URL and the presenter identity of the specific presenter;
establishing a browsing session at the destination URL between the consumer and the fulfillment server for:
browsing an electronic catalogue of products,
associating the presenter identity with activity occurring during the consumer's browsing session,
facilitating purchase of one or more products from the electronic catalogue; and
accrediting the specific presenter at least for purchases made during the browsing session.

15. The computer system of claim 14 to perform a method further comprising:
generating a point of interest tracking (POIT) code, at a code generation server, for embedding the tracking URL and presenter identity of the specific presenter therein; and
wherein the receiving of the tracking URL from the consumer further comprises
decoding the POIT code for extracting at least the tracking URL therefrom, and
establishing a connection with the internet between the consumer and the tracking URL for initiating the browsing session.

16. A non-transitory computer-readable medium, storing computer-executable instructions that, when executed on one or more processors, cause the one or more processors to perform acts comprising:
generating a point of interest (POIT) code associated with and for display by a specific presenter of a plurality of presenters, the code being capable of being scanned by a mobile electronic device and embedding at least a tracking URL including at least a destination URL and a presenter identity of the specific presenter;
establishing communication between the mobile electronic device and the destination URL by extracting the destination URL from the POIT code;
presenting an electronic catalogue at the destination URL;
enabling browsing of the electronic catalogue;
facilitating purchase of one or more products from the electronic catalogue;
determining association between the POIT code and the product for identification of the specific presenter who displayed the POIT code; and
crediting specific presenter associated with the POIT code.
